(19) United States
(12) Patent Application Publication
(10) Pub. No.: US 2003/0018587 A1
(43) Pub. Date: Jan. 23, 2003

(54) Checkout system for on-line, card present equivalent interchanges

(76) Inventors: Oliver T. Althoff, North Wales, PA (US); Thomas S. Johnston, North Wales, PA (US); Michael J. Abbott, New Canaan, CT (US)

Correspondence Address: Dike, Bronstein, Roberts & Cushman, Intellectual Property Practice Group, Edwards & Angell, LLP, P. O. Box 9169, Boston, MA, 02209, US

(21) Appl. No.: 09/910,256

(22) Filed: Jul. 20, 2001

(51) Int. Cl. G06F 17/60

(52) U.S. Cl. 705/64; 705/26

(57) ABSTRACT

The present invention includes methods for providing merchant's with verified information about a user during a remote electronic transaction; methods for carrying out a verified, remote electronic transaction over a network by providing verified user information to a merchant's server, which information is necessary to complete the verified transaction; and systems enabling a user to complete a verified, remote electronic transactions over a network with a merchant, wherein the verified transactions include providing the merchant's server with verified user information. Moreover, the present invention provides methods and systems for conducting verified, remote electronic transactions using a single access code. The system comprises one or more verifying servers that are maintained by the merchant or a third party; one or more servers that are maintained by a merchant, one or more digital, electronic devices that are maintained by the user or by a third party, and a machine-readable-data structure that interfaces with said digital, electronic device. The machine-readable data structure comprises at least one internal microprocessor that controls at least one internal semiconductor memory, having a secured first portion for storing verifiable user information and an unsecured second portion. Verifiable user information about the user, which is necessary to complete a verified, card present equivalent transaction, resides in the secured first portion of the semiconductor memory. A security algorithm and a previously registered security code reside on the unsecured second portion of the semiconductor memory. The verifiable user information is provided to the merchant server or, alternately, to the verifying server after the machine-readable data structure is read and a single access code that matches the previously registered security code is provided by the user.

### FIELD OF THE INVENTION

The present invention relates to methods of and systems for conducting secure sales transactions on the Internet. More particularly, the present invention relates to a checkout system and method for on-line sales transactions that minimizes inconvenience to consumers by simplifying merchant checkout procedures and, furthermore, produces for the merchant's benefit “card present” equivalent transactions.

### DESCRIPTION OF THE RELATED ART

The use or intended use of “smart” cards, e.g., credit, debit, bank or other wallet-size cards, which are equipped with a microprocessing chip for storing and managing certain secure information, as a more secure alternative to conventional credit cards is well known to those skilled in the art. Credit card issuers and merchants who accept credit cards as payment in their transactions typically recognize two commercial interchange transaction types, i.e., card present and mail order/telephone order transactions. The first transaction type is a “card present” interchange, in which a consumer with his or her credit card is physically present in the merchant's store at the time of the transaction. Indeed, in a card present interchange, the transaction is authorized by use of the consumer's card, e.g., by passing it through a magnetic stripe (“mag stripe”) reader or similar credit card reading device. After authorization, the consumer signs a sales slip for verification and the signature routinely is compared visually to the consumer's authentication signature on the reverse side of the credit card. For added security against fraudulent transactions, some credit cards display an image of the consumer on the card, which allows a merchant, further, to verify visually that the cardholder and the consumer making the purchase are one and the same. If need be, a merchant may ask a consumer for additional proof of identification, e.g., a driver's license, or to include some personal information, e.g., a local phone number, as a further means of verifying that the consumer present in the store who is tendering the credit card is the true cardholder.

Thus, card present interchanges have authorization and verification steps that substantially reduce fraudulent use of credit cards in comparison to mail order/telephone order transactions. Accordingly, because potential for fraudulent use is less, the interchange fee that card issuers charge merchants, e.g., about 1½ percent, is substantially less than the fee charged for the less secure transaction type, e.g., about 2½ percent, as described in greater detail below.

The second interchange type is called a “mail order/telephone order” (“MOTO”) transaction. A MOTO transaction entails an interchange at which neither the card nor the consumer is physically present at the time of the transaction. Because neither the consumer nor the card is present at the transaction, the opportunity for fraudulent use is more acute. Accordingly, the interchange fee charged by card issuers for a MOTO transaction is substantially higher than that charged for a card present transaction. Understandably, merchants prefer card present transactions to minimize the fee surcharge that results when an interchange is other than card present.

As its name implies, MOTO transactions are common with mail order and telephone order businesses. Furthermore, MOTO transactions are commonly associated with cyber-sales over the Internet. Given that current margins on goods and services sold over the Internet are relatively small, reducing interchange fees can boost business's profit margin substantially. Indeed, some analysts estimate profit margins at about two percent or less, as electronic businesses, i.e., e-businesses, forego current profits in exchange for greater market share and customer loyalty, hoping for larger profit margins in the future. The problem faced by merchants and card issuers alike, then, becomes one of producing a “card present” equivalent transaction, wherein neither the cardholder nor the card is physically present at the merchant's place of business at the time of the transaction, which, further, minimizes the potential for fraudulent use.

The following patents issued in the U.S. disclose means for providing secure transactions over the telephone, wireless, Internet, and the like:

Vardanyan, et al. (U.S. Pat. No. 6,079,621) discloses a secure card for e-commerce transactions that disposes an amorphous film on the card's mag stripe. When the card is secure, molecular dipole movement in the film induces an electromagnetic field that prevents access to information secured on the card. A biometric, voice recognition device, or, in the alternate, a personal identification number (PIN), changes dipole orientation of the electromagnetic field so that secure information can be read. One of the shortcomings of this device is that the card must be supplied with sufficient power at all times to maintain security. Indeed, loss of power, even for a nanosecond, would ruin the card. Moreover, other magnetic fields can erase or otherwise damage the integrity of data stored in the card's magnetic stripe.

Boesch, et al. (U.S. Pat. No. 6,092,053) discloses a system and method for establishing a communication link, e.g., a “network”, between a consumer's computer, a merchant's server, and a “payment” server to provide purchasing information pertaining to a known consumer, e.g., an electronic wallet or “cookie”, which is stored in memory in the payment server, to the merchant's server to complete a transaction. The Boesch system and method require consumers to provide information, e.g., an identification (“ID”) number, email address, credit card number, and/or a passphrase, to enable the payment server to identify the consumer. Once the payment server has identified the consumer, the payment server transmits the consumer's cookie to the merchant's server and the transaction can be completed.

One of the problems associated with the Boesch patent is that the information the “payment” server provides to the merchant is not verified. Moreover, the transaction is MOTO rather than “card present”.

Related to Internet transactions, from a consumer's perspective, is the inconvenience that often accompanies an Internet sales transaction. Most, if not all, merchants at check-out require a consumer (i) to “sign-in”, if the consumer is a repeat or known customer who has previously completed an account; or (ii) to “create an account” if the consumer is a first-time, unknown buyer to that merchant. In either case, check-out at one time or another requires consumers to provide an inordinate amount of personal information about him- or herself, some of which is pertinent to the transaction, e.g., shipping address, billing address, credit card type, number, and expiration date, etc., and some of which is less so, e.g., email address, phone number, shipping preferences, whether the consumer agrees to be included on a mailing list, etc. Inputting information is irksome, requiring, in many instances, several minutes to enter data in forms that are displayed on multiple screens and that, in some instances, must be scrolled through until a “send” or “confirm” button is found and clicked-on.

Even more bothersome than having to fill in a check-out form is filling out a check-out form partially, omitting some required bit of information that the consumer inadvertently overlooked or intentionally withheld, which requires the consumer to replicate the entire check-out form again. Non-user friendly checkout forms often create unpleasant Web sites experiences, which substantially decrease the likelihood that a consumer will return to the same Web site. Moreover, oppressive checkout forms often induce consumers to abort the transaction altogether. Some researchers estimate that as many as 60 percent of all initiated Internet transactions are aborted before the transaction is perfected.

When a new account is opened and the consumer's information has been newly entered into a merchant's checkout form, merchants frequently if not universally offer to create a “cookie” for the consumer. This cookie generally stores all or substantially all of the information—although, usually not credit card information—which the consumer entered during checkout in the merchant's or a third party's server. Information is stored under an ID name and password, which consumers create during or as a prerequisite to checking out. Cookies substantially facilitate future transactions between a consumer and that particular merchant, but there are disadvantages associated with this system.

One disadvantage among consumers who do a lot of e-shopping with a variety of online vendors is that consumers must remember and safeguard a plethora of discrete ID names and passwords for each vendor. Some merchants even include a “password hint” entry in conjunction with the ID name and password, intending to jar the consumer's memory to recall the ID name and password. In the alternate, many consumers re-use the same ID name and password for all or substantially all vendors, which effectively reduces the information that must be remembered to a single ID name and password. However, redundant use of ID names and passwords increases risk of loss. Indeed, once one's ID name and password has been compromised, then, they all have been compromised.

A second disadvantage of this system is one of privacy and fear of “Big Brother.” Merchants, especially those who are working on narrow margins, frequently sell customer lists to third parties. Hence, a consumer who has set up an account with one merchant can wind up on mailing or e-mailing lists of other merchants. Moreover, the consumer often has no control or no say as to whether or not his or her information may be transferred or used by the merchant in other ways.

### SUMMARY OF THE INVENTION

Thus, from a merchant's perspective, it would be desirable to provide a system and a method for producing secure, card present equivalent interchanges for online sales transactions to substantially minimize credit card fees paid by merchants to card issuers.

Moreover, it would be desirable for such a system and method to produce secure, card present equivalent interchanges that are quick and easy in order to reduce the likelihood that a consumer will abort the transaction.

Furthermore, from a consumer's perspective, it would be equally desirable to provide a system and method that replace a plethora of unique ID names and passwords for a multitude of online merchants with a single, machine-readable data structure, e.g., a smart card, and a single, registered personal access code.

The term “smart card” will be used herein to refer to machine-readable data structures; however, machine-readable data structures are not limited to smart cards.

Moreover, it would be desirable to provide a system and method for automatically populating merchant check-out forms with verified user information stored securely on the smart card, which substantially facilitates check-out from compatible merchant Web sites.

The term “verified user information” will be used herein to refer to information that is stored in a secure memory on the smart until it is unlocked by an access code, which is necessary to complete a “card present” equivalent transaction.

The present invention, therefore involves a method for carrying out verified, remote electronic transaction between consumers, or users, and merchants by providing verified user information, which is necessary to complete a verified, card present equivalent transaction, the method comprising the steps of: interfacing a machine-readable data structure with a digital, electronic device; unlocking the machine-readable data structure to access a database of verified user information contained in a memory cache disposed on a chip on the data structure; and providing the verified user information to the merchant to complete the transaction.

Furthermore, the present invention includes a method for providing verified user information to merchants during an electronic transaction, the method comprising the steps of: providing an access code; verifying this access code against a previously-registered personal access code that is stored in a secured memory cache on the card; providing user information to a verifying server; and providing a merchant(s) with the verified user information to complete the “card present” equivalent transaction.

Finally, the present invention includes a system enabling a user to complete verified, remote electronic transactions over a network, wherein the verified transactions are completed by providing the merchant's server with verified user information. The system comprising:

a network;

at least one remote verifying server, wherein said remote verifying server is connected to the network and is capable of receiving and verifying verified user information;

at least one remote server maintained by a merchant, wherein the merchant's at least one remote server is connected to the network and is capable of accessing said remote verifying server to receive verified user information therefrom;

at least one remote digital, electronic device that is maintained by the user or by a third party, wherein said digital, electronic device is connected to the network; and

a machine-readable-data structure that interfaces with said digital, electronic device.

### BRIEF DESCRIPTION OF THE DRAWINGS

For a fuller understanding of the nature and desired objects of the present invention, reference is made to the following detailed description taken in conjunction with the accompanying figures wherein like reference character denote corresponding parts throughout the several views and wherein:

FIG. 1 is an illustrative example of a mail order/telephone order type transaction of the prior art;

FIG. 2 is illustrative example of a preferred embodiment of the present invention;

FIG. 3 is an illustrative embodiment of an integrated circuit (“smart”) card; and

FIGS. 4a and 4b are illustrative embodiments of a method of providing verified consumer information to produce a card present equivalent transaction.

### DETAILED DESCRIPTION OF THE INVENTION AND ITS PREFERRED EMBODIMENTS

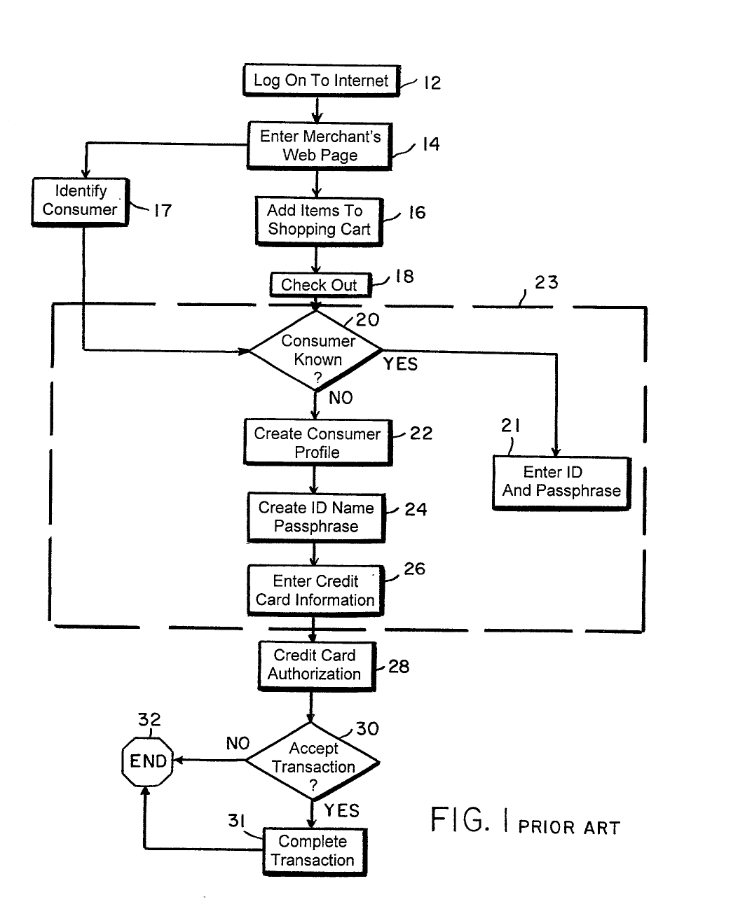

The present invention includes a system and method for producing a “card present” equivalent business transaction between one or more consumers and one or more merchants over a network, e.g., the Internet, a wide area network (“WAN”), a local area network (“LAN”), and the like. Use of credit cards in e-commerce sale of goods and/or services has skyrocketed in recent years, which has produced numerous problems for cardholders (“consumers” or “users”), merchants, card issuers, and third parties. FIG. 1 illustrates a typical mail order/telephone order, i.e., “MOTO”, transaction 10, which transaction, as the name implies, is common with mail order, telephone order, and, heretofore, e-commerce businesses. MOTO transactions 10 are characterized by the absence of a consumer and the consumer's credit card at the merchant's normal place of business. Indeed, within the context of a sale of goods and/or services over the Internet, a consumer logs onto the Internet 12 in a manner that is well known to those of ordinary skill in the art. Using a Web browser—software for which is downloaded into the consumer's microprocessor, consumers request a specific merchant's Web page 14, e.g., by inputting the merchant's uniform resource locator (“URL”) address if known or by performing a search, which involves inputting one or more search terms to identify any number of Web sites (“hits”) that are associated with those search terms. Normally, once a consumer has decided which hit he or she is interested in visiting, the consumer manifests that intent either by manually typing in the desired URL or, more commonly, simply by clicking a button, which comprises a hyperlink, that is provided in the brief description of the hit's Web site. The hyperlink already contains the Web site's URL, so consumers do not have to manually input the desired URL. A universal protocol function causes the consumer's Web browser to download that Web site.

For example, inputting a merchant's URL Web page address transmits an interrupt to the merchant's Web site, essentially telling the merchant's Web server to transmit the contents of the merchant's Web page to the consumer's Web browser in a human-readable format, e.g., hyper-text mark-up language (“HTML”). Once the consumer has accessed the merchant's Web site, he or she can scroll up and down and jump from page to page of the merchant's Web site in search of goods and/or services. When a consumer desires to purchase any of the goods and/or services found on a merchant's Web site, he or she manifests that desire by adding the desired good and/or service to a virtual shopping cart 16, which is, e.g., a temporary memory cache on the merchant's server. Once the consumer has finished his or her shopping, he or she usually indicates his or her desire to “check out” 18 by, e.g., clicking on a “check out” window or button.

Most merchant's servers then go through one or more sub-routines to try to identify the consumer 20. In some instances, a merchant may have installed a watermark on the consumer's Web browser so that as soon as a repeat consumer enters the merchant's Web page, the merchant's server knows who the consumer is 17. Normally, however, most merchant's servers prompt the consumer to enter, e.g., his or her identifier and passphrase 21, which initiates a detailed consumer verification process 23.

As all consumers are, at one time or another, unknown to every merchant's server, the steps of creating a consumer profile 22, e.g., an electronic wallet or “cookie”; creating a secure memory for the consumer profile 24; and providing credit card information 26 will be discussed first. Indeed, once an unknown consumer manifests his or her intent to check-out, most merchant's servers generally transmit a consumer profile template to the consumer's Web browser to download. This template typically contains a series of labeled spaces, in which consumers can input personal information, e.g., their name, street address, town and state of residence, zip code, telephone number, email address, and the like. The consumer can opt at some point to save this information to create a consumer profile 22 or not. Failure to save the information, i.e., to create a personal profile, requires the consumer to repeat the identification process each time the consumer desires to purchase goods and/or services from the same merchant.

The consumer who desires to save his or her personal information also is asked, generally before or after providing his or her profile information, to select a unique consumer identifier and passphrase 24, which, as will be discussed below, facilitate and abbreviate future check-outs with the same merchant. The consumer identifier basically is an address in memory at which the consumer profile is stored. The passphrase is an enabler that effectively enables the microprocessor to “read”, i.e., to access, the consumer's personal information stored at the appropriate consumer profile address. Generally, the identifier can be anything of the consumer's choosing; however, some merchants require consumers to use their email address. Most merchants provide greater latitude to consumers in selecting a passphrase. Some further provide for a “hint phrase”, which consumers can use to jar their recollection as to what their passphrase is.

The merchant's server 28 then seeks authorization and verification from the card issuer or a third party 26, using verification software provided therefor by the card issuer or a third party. Methods of authorization and verification are know to those skilled in the pertinent art take on many shapes and forms. One illustrative embodiment is found in U.S. Pat. No. 6,092,053 to Boesch, which is incorporated herein by reference. However, once the merchant's server receives authorization and verification from the card issuer, the merchant's server causes the consumer's browser to display, e.g., usually with a pop-up window, a message prompting the consumer to commit to the purchase 30. If the consumer no longer desires, for whatever reason, to make the purchase, the program ends 32 and there is no sale. On the other hand, if the consumer wants to commit to the transaction 31, then he or she clicks on the appropriate box and the merchant's server sends confirmation messages of the transaction to the consumer, e.g., via email, and to the card issuer and/or third party according to the merchant's order database and transaction systems.

The present invention discloses a system that operates using anew method to produce a “card present” equivalent transaction, wherein a consumer and the consumer's card are “virtually” present in the merchant's “virtual” place of business. Indeed, according to the present invention, a consumer's virtual presence in a virtual store produces a “card present” equivalent interchange that benefits merchants, who pay less in transaction fees, consumers, whose shopping experience has been facilitated substantially, and card issuers, who ostensibly receives more business from subscribing merchants.

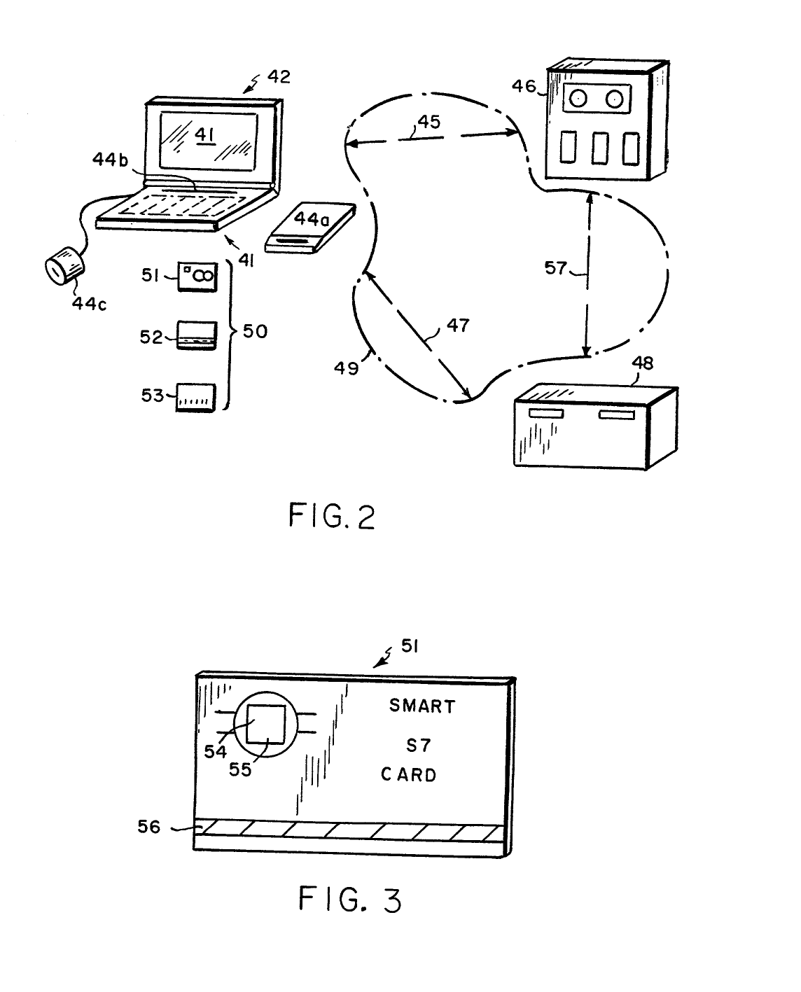

One preferred embodiment of a system according to the present invention will be described in greater detail by referring to FIG. 2, it being understood that the present invention is not to embodiment described in detail herein.

FIG. 2 illustrates a schematic of the elements of one preferred embodiment of the present invention 40. The system 40 includes one or more networks 49 having one or more digital, electronic devices 42, e.g., computer, server, microprocessor, and the like maintained by the consumer; and one or more remote merchant servers 48. In another preferred embodiment, the merchant server 48 can be in communication with one or more local or remote verifying servers 46, which are maintained by the merchant or a third party and allow the merchant to authenticate and verify the verifiable user information that the consumer provides during the transaction. The term “verifying server” will be used herein to refer to software, which is provided by the card issuer or third party, that can identify transaction data from the consumer and verify that, more likely than not, the data is “verified user information” that has been transmitted from an unlocked secure memory cache on the consumer's integrated circuit chip. As will be described in greater detail below, in the embodiment illustrated in FIG. 2, the merchant server 48 can perform the functions of the one or more verifying servers 47. Moreover, and most importantly, in this embodiment, the system 40 includes a machine-readable data structure 50 that can interface with the consumer's digital, electronic device (“consumer server”) 42, e.g., through a reading device 44.

Preferably, each consumer server 42 communicates with one or more merchant servers 48 via a first communication link 47, e.g., the Internet. With the embodiment that includes a separate verifying server 48, consumer servers 42 communicate first with one or more verifying servers 46 via a second communication link 45, e.g., a WAN, LAN, wireless, the Internet, and the like, and the verifying server 46 communicates with the one or more merchant servers 48 via a third communication link 57, e.g., a WAN, LAN, wireless, the Internet, and the like. The above-mentioned first, second, and third communication links 45, 47, and 57 are not intended to be limiting; rather, merely illustrative examples of possible network types.

Indeed, the one or more merchant servers 48 preferably have software and memory that allow them to communicate with one or more consumer server 42. Communication, in this sense, includes without limitation (i) transmitting data to the consumer server's 42 Web browser for display on a screen 41 in a human-readable format, e.g., HTML; (ii) providing, gathering, and storing, temporarily or permanently, verified personal profile information about each consumer desiring to make a purchase; (iii) gathering and storing verified user information to complete one or more sales transactions; and (iv) transmitting one or more messages and/or prompts to consumer servers 42 to consummate the transaction and, if need be, to provide a record of the transaction.

In embodiments that include one or more separate verifying server (can this be replace with something besides a server?) 46, the one or more verifying servers 46 also include software and memory that allow them to communicate with one or more consumer servers 42 and with one or more merchant servers 48. Communication, in this sense, includes without limitation (i) receiving and storing verifiable user information about one or more consumers; (ii) verifying the verifiable user information; and (iii) transmitting the verified user information to one or more merchant servers 48 to enable a verified, “card present” transaction between the consumer and the merchant. Here again, when the merchant server 48 is its own verifying server, the merchant server 48 performs these communication functions itself.

Consumer servers 42 include Web browsing software, which allows consumer servers 42 to download and display one or more Web pages from one or more merchant Web sites while in communication with one or more merchant servers 48. Communication in this sense includes without limitation (i) browsing a merchant's Web site; (ii) creating a virtual shopping cart containing goods and/or services to be purchased; (iii) initiating a transaction, e.g., “check-out”, for the purchase of goods and/or services placed in the virtual shopping cart; (iv) transmitting verified user information to the merchant servers 48 or, in the alternate, to the verifying server 46, which information is necessary for a “card present” transaction; and (v) consummating the verified sales transaction. Indeed, the consumer server's 42 Web browser software allows consumers to access, browse, and transact business on a merchant's Web site.

In alternate embodiments, which include a separate verifying server 46, consumer servers 42 also include software for communicating with one or more verifying servers 46. Communication, in this sense, includes without limitation, transmitting verifiable user information to the one or more verifying servers 46 for verification.

Preferably, each consumer server 42 further communicates with a reading device for reading machine-readable data structures 50. The reading device can include without limitation, e.g., a bar code scanning device 44c for reading a bar-coded data structure 53, a swipe card-type device 44b for reading a mag stripe data structure 52, and/or a card inserting device for reading an integrated circuit card 51, each of which are well known in the art. Each exemplary reading device 44a, 44b and 44c reads personal information about the consumer that is stored in or on the surface of the data structure 50 and, further, initiates one or more micro-programs that are stored in the consumer server 42 to fetch, decode, and execute a verification routine.

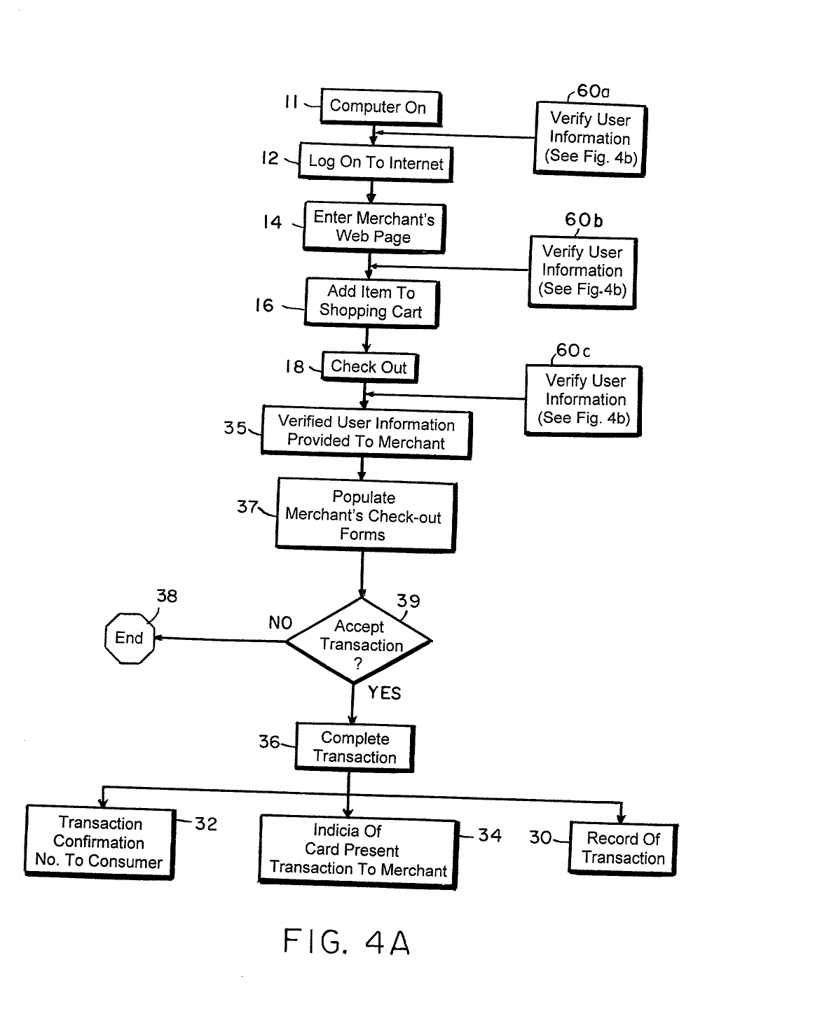

In the embodiment shown in FIG. 3, the machine-readable data structure 50 comprises an integrated circuit (“smart”) card 51 that, further, comprises a substrate 57, at least one internal microprocessor 54, i.e., computer chip, that contains data and micro-programs to control at least one secure, internal semiconductor memory 55, and at least one mass-storage memory 56, which memory 56 is not secured and readily accessible, e.g., by the reading device 44a. Of significant importance to the present invention is that the internal semiconductor memory 55 and more particularly the verifiable user information contained on the chip remains inaccessible until unlocked by a security algorithm, which is contained in one or more micro-programs. Indeed, only when the internal semiconductor memory 55 has been unlocked can the data structure 51 be used to complete a verified, “card present” equivalent transaction. A preferred method of unlocking the internal semiconductor memory 55 will be described in greater detail below.

Consumers apply for and receive machine-readable data structures 50, e.g., credit cards, debit cards, smart cards, and the like, from card issuers and/or third parties, e.g., bank, savings and loans, department stores, retail stores, and the like, in a manner that is well known in the art. Typically, applicants complete an application form, providing in the process a host of personal information and credit information. Then, cards issuers and/or third parties perform a credit search, usually completed in a manner of minutes. Finally, card issuers and/or third parties make a determination of whether to issue a machine-readable data structure 50 to the applicant and, if so, the credit limit of the applicant.

As mentioned previously, in accordance with this invention, in one preferred embodiment the machine-readable data structure 50 comprises a smart card 51, of a type that is well known to the art. However, those skilled in the art can practice the present invention using other data structures 50, e.g., a mag stripe card 52, a bar-coded card 53, and the like within the scope and spirit of the invention.

FIG. 3 shows schematically an embodiment of a smart card 51 containing a securable, semiconductor memory 55 stored internally in a microprocessor chip 54. The securable memory 55 stores a host of personal and shopping information about the consumer, hereinafter “user information”. Moreover, the card 51 contains information, i.e., a registered personal security code, used to verify that the person using the card 51 during a particular transaction is the true cardholder. The internal memory 55 remains locked, i.e., secured, however, and the user information contained therein remains inaccessible until a security algorithm unlocks the memory 55. Preferably, the security algorithm is initiated by a micro-program contained in the mass storage memory 56 or contained in an unsecured portion of the internal semiconductor memory 55 and/or initiated by software downloaded in the consumer server 42. Once the security algorithm unlocks the user information stored in the card's memory 55, the information becomes “verified”. Furthermore, once a consumer's card 51 is “verified”, it is suitable for and qualifies for verified, “card present” equivalent transactions, which will be discussed in greater detail below.

In preferred embodiments of the present invention, which include automatic population of check-out forms, the user information contained in the locked memory 55 of the consumer's card 51 includes all of the information that merchants traditionally require in their check-out forms, e.g., the consumer's name, address, telephone number, email address, credit card number and expiration date, billing address, shipping address, shipping preferences, and the like. Indeed, preferably user information is pre-mapped in the integrated circuit chip 54 of the card 51 when the card 51 is first issued to the consumer by the card issuer and/or third party. This greatly facilitates automatically populating merchant check-out forms and/or completing merchant order databases and transaction systems. To further facilitate this process, the merchant's check-out forms, order databases and/or transaction systems can be similarly pre-mapped. Moreover, and most important, the information contained in the locked memory 55 of the consumer's card 51 includes verification indicia, which, when provided to a merchant, e.g., generally in an encrypted form, signify to the merchant, the card issuer and/or a third party that the user information is verified and that the transaction is a “card present” equivalent transaction. As a result, the merchant pays a reduced fee to the card issuer and/or third party for the transaction.

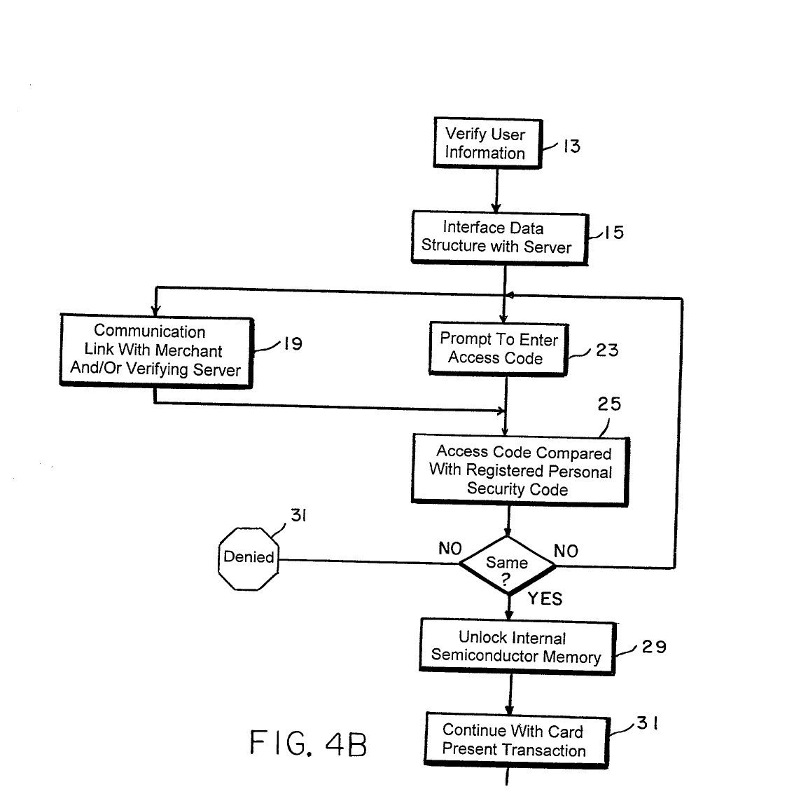

Having described one system of the present invention, a preferred embodiment of a method of conducting a card present equivalent transaction over a network using this system will now be described using FIGS. 4a and 4b. The preferred method of carrying out a verified, electronic transaction 100 generally comprises the steps of (i) interfacing a machine-readable data structure 50 with a digital, electronic device 42; (ii) providing an access code to unlock a secure memory cache 55 contained in a microprocessor 54 of a machine-readable data structure 50; and (iii) providing verified user information contained in the memory cache 55 to one or more merchants to complete a transaction. Alternately, the verified user information can be provided to a verifying server 46.

Prior to initiating the transactional steps outlined above, though, a consumer powers up, i.e., activates, his or her digital, electronic device 11, e.g., his or her computer or server. Indeed, a consumer first activates, i.e., turns on, his or her server 42, which, as a result, causes an operating system contained therein to fetch, decode, and execute a number of programs to render the computer operable 11. Once the server is operable, preferably, the consumer, who knows that he or she is seeking to purchase one or more goods and/or services on the Internet, can verify his or her user information 13.

Indeed, according to the first step of the method listed above, a consumer's machine-readable data structure is made to interface with a digital, electronic device 15. The timing of this interface 15, however, is not critical to practicing the invention. Indeed, the interface can take place immediately after activating the digital, electronic device 60a; subsequent to downloading a merchant's Web site onto the consumer's server 60b; or after the consumer indicates that he or she desires to “check-out” and complete an electronic transaction 60c.

Preferably, the interface mechanism 44 includes a device that can read information stored on the surface of the consumer's machine-readable data structure 50, in a manner that is are well known in the art. In one preferred embodiment, the device comprises a smart card reader 44a. Alternate embodiments include a swipe card reading device 44b and/or a bar code scanning device 44c. For simplicity in describing the invention, only the smart card embodiment will be described.

After the smart card has been read 15, the consumer server executes a software and/or hardware program that establishes a communication link 19 between the consumer server and one or more merchant servers or, alternately, with one or more separate verifying servers that are maintained by the merchant. Concurrently, the software and/or hardware program causes an interrupt to occur on the consumer server. As a result, a message appears, e.g., pops-up in a window on the consumer's computer screen, which prompts the consumer to enter his or her access code 23, using the server keyboard 41. The access code and corresponding registered personal security code can be a word, phrase, and/or any combination of numbers, letters, and/or characters of the consumer's choosing. The access code examples provided are illustrative and not intended to be limiting.

Once the consumer enters his or her access code 23, a security algorithm that is stored either in the consumer server memory or in the unsecured portion of the internal semiconductor memory compares the input access code with the previously registered personal security code that is also stored, e.g., in encrypted form, in the same unsecured portion of the internal semiconductor memory 25.

For example, the security algorithm can include an address in the unsecured memory, wherein the consumer's register personal security code is stored. Thus, when the security algorithm is running the input access code can be compared to the contents at the address 25, i.e., the consumer's register personal security code. If the entered access code matches the previously registered personal security code exactly, then the security algorithm verifies that the rightful cardholder is present with his or her card. Correspondingly, the security algorithm initiates a software and/or hardware program to unlock the internal memory storage of the consumer's card 29. For example, the security algorithm can communicate a special binary logic code that unlocks the internal memory storage 29 contained in the card. With the internal memory storage unlocked, the consumer is able to transact any number of remote, online transactions with one or more merchants, all of which are “card present” equivalent transactions 31 for which merchant's pay the reduced “card present” fee rather than the higher MOTO fee.

In the alternate, if the access code does not match the consumer's previously registered personal security code in the database, then “card present” status is denied 31 and/or the consumer can return to the appropriate prompt and re-enter another access code 33. If “card present” status is denied, i.e., the cardholder and user information is not verified. Consumers can continue to transact remote, online purchases; however, the transactions are not “card present” equivalent transactions. Accordingly, merchants could have to pay the card issuer and/or third party the MOTO fee for the transaction rather than the “card present” fee.

To continue, in the next step, consumers log onto the Internet 12 in a manner that is well known to those of ordinary skill in the art. Using a Web browser, consumers request a merchant's Web page 14, e.g., by inputting the merchant's URL if known or by inputting one or more search terms to identify any number of hits that are associated with the search terms. Normally, once a consumer has decided which hit he or she is interested in visiting, the consumer manifests that intent either by manually typing in the URL or simply by clicking onto a, e.g., hyperlink, that is provided.

Inputting the merchant's URL Web page address causes an interrupt to be transmitted to the merchant's Web site, essentially telling the merchant's Web server to transmit the contents of the merchant's Web page to the consumer's Web browser in a human-readable format, e.g., HTML. Once the consumer has accessed the merchant's Web site 14, he or she can scroll up and down and jump from page to page of the merchant's Web site in search of goods and/or services. If a consumer desires to purchase a good and/or service found on a merchant's Web site, he or she manifests that desire by adding the good and/or service to a virtual shopping cart 16, which is, e.g., a temporary memory cache on the merchant server. Once the consumer has finished his or her shopping, he or she indicates his or her desire to “check out” 18 by, e.g., clicking on a “check out” window or button.

Having unlocked the internal memory storage on the consumer's card 29 and indicated a desire to check-out 18, verified user information about the consumer can be communicated preferably via a first communication link to one or more merchant servers 35. In the alternate embodiment, verified user information can be communicated via a second communication link to one or more verifying servers 35. The merchant server and/or verifying server read the verified user information searching indicia that the transaction is compatible with a “card present” equivalent transaction. Preferably, this verified user information is communicated to the merchant server to populate the merchant's check out form 37 and/or for use in the merchant's order database and transaction systems. Indeed, in a preferred embodiment, the consumer's verified user information automatically populates the merchant's check-out form. However, alternately, the consumer's verified information also can be placed in a merchant's check-out form 37 manually, e.g., using a drag and drop technique that is well known in the art. Moreover, in yet another embodiment, merchant servers can include server-side software that accepts direct transmission of verified user information without visibly populating a check-out form.

After the merchant's check-out form is filled out 37 properly with all necessary information, the server-side software in the merchant server prompts the consumer to commit to the transaction 39. Preferably, this prompt comprises one or more pop-up windows that query the consumer as to whether he or she wants to complete the transaction 39. A response in the negative aborts the transaction altogether 38. A response in the affirmative, however, consummates the transaction 36. Furthermore, the merchant's order database and transaction system preferably performs at least one of recording the transaction 30 internally and with the card issuer and/or third party; communicating a message to the consumer that includes a transaction confirmation number 32. Moreover, the verified user information communicates indicia to the merchant server that the transaction was a “card present” equivalent transaction 34.

While a preferred embodiment of a method of practicing the disclosed invention has been provided and described in great detail, other embodiments incorporating changes, modifications, and the like will become clear to those skilled in the art. For example, the timing of verification process 60a does not have to occur immediately following server start-up 11. Indeed, the timing of the verification process can take place after a consumer has entered a merchant's Web page 60b, or, alternately, the timing of the verification process can take place after a consumer has expressed a desire to check-out 60c.

Furthermore, the consumer's Web browsing software can include one or more software and/or hardware programs that actively seek out merchant Web sites that subscribe to the “card present” equivalent method described herein. Moreover, merchant Web sites also can include server software that identifies consumers, e.g., using a watermark, who can transact a verified, “card present” equivalent exchange, which allows merchants to further expedite check-out procedures.

What is claimed is:

1. A method for carrying out over a network at least one verified, remote electronic transaction between at least one user and at least one merchant by providing to a merchant's server verified user information, which is necessary to complete the verified transaction, the method comprising:
interfacing a machine-readable data structure of the user with a digital, electronic device, wherein the digital, electronic device is connected to the network;
providing an access code via the digital, electronic device to unlock the machine-readable data structure and to thereby access a database of verifiable user information contained therein; and
providing the verifiable user information to the merchant over a communication link of the network to complete the transaction.

2. The method of claim 1, wherein verifiable user information is compared with similar user information residing on a verifying server on the network.

3. The method of claim 1, wherein the machine-readable data structure is selected from the group consisting of an integrated circuit card, a magnetic stripe card, and a bar coded card.

4. The method of claim 1, wherein at least one merchant is a verifiable merchant.

5. The method of claim 1, wherein the machine-readable data structure is unlocked by providing an access code through the digital, electronic device that matches a previously registered personal security code.

6. The method of claim 5, wherein the previously registered personal security code is contained in unsecured memory on the machine-readable data structure.

7. The method of claim 1, wherein a first communication link between said digital, electronic device and the merchant's server is established following the unlocking of the machine-readable data structure.

8. The method of claim 1, wherein the communication link between the digital, electronic device and the merchant's server is established through a second communication link from said digital, electronic device to a verifying server and then through a third communication link from said verifying server to said merchant's server.

9. The method of claim 1, wherein verified user information is transmitted to at least one merchant's server to populate at least one merchant's check-out form.

10. The method of claim 9, wherein verified user information is transmitted to at least one merchant's server to populate at least one merchant's check-out form, following verification of the user's information at a verifying server.

11. The method of claim 9, wherein said check-out form is populated manually by the user.

12. The method of claim 9, wherein said check-out form is populated automatically.

13. The method of claim 1, wherein verified user information is transmitted to at least one merchant's server by automatically populating a merchant's order database and transaction systems.

14. The method of claim 13, wherein verified user information is transmitted to at least one merchant's server by automatically populating a merchant's order database and transaction systems following verification of the user's information at a verifying server.

15. The method of claim 1, wherein the merchant's server contains server-side software to accept direct transmission of verified user information from the machine-readable data structure, without using forms.

16. The method of claim 1, wherein the network is selected from the group consisting of local area networks, wide area networks, the Internet, and Wireless and Mobile networks.

17. The method of claim 1, comprising the additional steps of:
providing authorization from the user to complete said verified transaction;
completing said verified transaction;
providing at least one message to the merchant, indicating that said verified transaction comprises a valid, card present equivalent transaction; and
providing at least one message, comprising at least one transaction number, to the user's digital, electronic device to confirm the sale.

18. A method for providing verified information about at least one user over a network to at least one merchant during at least one electronic transaction, the method comprising the steps:
providing at least one access code provided by the at least one user and unique user information to at least one verifying server, wherein said verifying server is connected to the network;
verifying said access code and unique user information; and
providing verified user information to the at least one merchant.

19. The method of claim 18, wherein said access code is verified by comparing said access code with a previously registered security code stored on a machine-readable data structure.

20. The method of claim 19, wherein said access code is verified by presenting said access code through a digital, electronic device to the machine-readable data structure.

21. The method of claim 18, wherein said unique user information is released for verification against similar data stored in at least one database of the at least one verifying server.

22. The method of claim 21, wherein said unique user information is released for verification against similar data stored in at least one database of the at least one verified server upon verification of the access code.

23. The method of claim 18, wherein the network is selected from the group consisting of local area networks, wide area networks, the Internet, and Wireless and Mobile networks.

24. A system enabling a user to complete one or more verified, remote electronic transactions over a network with at least one merchant, said merchant having a server, wherein said verified transactions are completed by providing the merchant's server with verified user information, the system comprising:
a network;
at least one remote verifying server, wherein said remote verifying server is connected to the network and is capable of receiving and verifying verified user information;
at least one remote server maintained by a merchant, wherein the merchant's at least one remote server is connected to the network and is capable of accessing said remote verifying server to receive verified user information therefrom;
at least one remote digital, electronic device that is maintained by the user or by a third party, wherein said digital, electronic device is connected to the network and is capable of accessing said verifying server to transmit verified user information and said remote server maintained by a merchant to initiate and complete said verified, remote electronic transactions; and
a machine-readable-data structure, having at least one secure memory cache, which interfaces with said digital, electronic device.

25. The system of claim 24, wherein the system further comprises a registered personal security code that is stored in said secure memory cache of said machine-readable data structure.

26. The system of claim 24, wherein the machine-readable data structure comprises at least one of an integrated circuit card, a magnetic stripe card, or a bar coded card.

27. The system of claim 26, wherein the integrated circuit card, having a surface, further comprises:
at least one internal microprocessor,
at least one internal semiconductor memory, having a secured first portion for storing verifiable user information and an unsecured second portion, wherein said at least one internal semiconductor memory is controlled by said at least one internal microprocessor; and
at least one mass-storage memory, wherein said at least one mass storage memory is accessible from the surface of the card.

28. The system of claim 24, wherein said machine-readable data structure can be unlocked by a security algorithm.

29. The system of claim 28, wherein said machine-readable data structure can be unlocked by inputting an access code.

30. The system of claim 29, wherein said machine-readable data structure is unlocked after the access code inputted by the user is verified against a previously registered security code that is stored in said secured first portion of said internal semiconductor memory.

31. The system of claim 30, wherein said previously registered security code is resident in one or more memory on the machine-readable data structure.

32. The system of claim 29, wherein said system further comprises software capable of providing verified user information to at least one verifying server for verification upon prior successful access code verification.

33. The system of claim 24, wherein at least one verifying server provides verified user information to said merchant's server to populate a merchant's check-out form contained therein.

34. The system of claim 33, wherein said at least one verifying server provides verified user information to said merchant's server by automatically populating an order database and transaction system.

35. The system of claim 33, wherein said merchant's server contains server-side software to accept direct transmission of the user's machine-readable data, without using forms.

36. The system of claim 35, wherein said direct transmission of the user's machine readable data is stored originally on the user's machine-readable data structure.

37. The system of claim 33, wherein the user manually populates the merchant's check-out form by dragging verified user information from at least one pop-up window and dropping the dragged information into an appropriate location of the merchant's check-out form.
